(19) United States
(12) Patent Application Publication
(10) Pub. No.: US 2014/0278910 A1
(43) Pub. Date: Sep. 18, 2014

(54) METHOD AND APPARATUS FOR SUBJECTIVE ADVERTISMENT EFFECTIVENESS ANALYSIS

(71) Applicant: FORD GLOBAL TECHNOLOGIES, LLC, Dearborn, MI (US)

(72) Inventors: Randal Henry Visintainer, Ann Arbor, MI (US); Yimin Liu, Ann Arbor, MI (US); Perry Robinson MacNeille, Lathrup Village, MI (US); Oleg Yurievitch Gusikhin, West Bloomfield, MI (US)

(73) Assignee: FORD GLOBAL TECHNOLOGIES, LLC, Dearborn, MI (US)

(21) Appl. No.: 13/834,330

(22) Filed: Mar. 15, 2013

(51) Int. Cl. G06Q 30/02

(52) U.S. Cl. CPC G06Q 30/0242
USPC 705/14.41

(57) ABSTRACT

A system includes a processor configured to receive an advertisement. The processor is also configured to present the advertisement to a vehicle occupant. The processor is further configured to visually record an occupant response during the course of the advertisement presentation using a vehicle camera. The processor is additionally configured to analyze the visually recorded response to gauge a user reaction to the advertisement and based on the analysis adjust an advertisement variable metric with respect to the presented advertisement.

### TECHNICAL FIELD

The illustrative embodiments generally relate to a method and apparatus for subjective advertisement effectiveness analysis.

### BACKGROUND

From the television set to the sales associate in the store, advertisement is a form of human communication. Humans are especially good at communicating with other humans face-to-face, but throughout human history technologies have been developed to meet the communication needs of increasingly technical societies.

Human communication is a combination of both verbal and nonverbal interactions. Through facial expressions, body gestures and other non-verbal cues, a human can still communicate with others effectively. This is especially true in the communications of emotions. In fact, studies have shown that a staggering 93% of affective communication takes place either non-verbally or para-linguistically through facial expressions, gestures, or vocal inflections. Many findings and experiences within advertising field, also suggest that the visual communication of emotions should be intensified.

Advertising has a much more difficult task: to develop a common set of commonly understood exemplars and paradigms that serve as the foundation of complete communication necessary for communicating complex ideas. For this purpose vocal communication is preferred to text or text-to-speech (TTS) communication. Visual communication combined with voice is even better than voice alone such that both sides of a conversation can see and hear the other's voice, expressions and gestures. Where good communication is critical, face-to-face is still preferred which is why politicians and CEOs still travel to meet each other and retailers still need a sales force.

European patent application EP1557810 generally relates to a display arrangement including an image display device having two or more sets of images for display; a camera directed towards positions adopted by users viewing the display; a face detector for detecting human faces in images captured by the camera, the face detector being arranged to detect faces in at least two face categories; and means, responsive to the a frequency of detection of categories of faces by the face detector at one or more different periods, for selecting a set of images to be displayed on the image display device at that time of day.

U.S. Patent Application 2012/0265616 generally relates to systems and methods effective to dynamically select advertising content. In an example, target sensory content and identification information can be received for a target advertising zone. The target sensory content and the identification information can be analyzed to determine features of the target advertising zone. Based on the features meeting conditions of a predefined function, a subset of advertising content can be determined. In some embodiments, dynamically selecting advertising content can be performed on remote computing devices. Other embodiments can render the subset of advertising content for consumption in the target advertising zone.

U.S. Patent Application 2012/0243751 generally relates to facial information collected on a person and used to analyze affect. Facial information can be used to determine a baseline face which characterizes the default expression that a person has on their face. Deviations from this baseline face can be used to evaluate affect and further be used to infer mental states. Facial images can be automatically scored for various expressions including smiles, frowns, and squints. Image descriptors and image classifiers can be used during this baseline face analysis.

### SUMMARY

In a first illustrative embodiment, a system includes a processor configured to receive an advertisement. The processor is also configured to present the advertisement to a vehicle occupant. The processor is further configured to visually record an occupant response during the course of the advertisement presentation using a vehicle camera. The processor is additionally configured to analyze the visually recorded response to gauge a user reaction to the advertisement and based on the analysis adjust an advertisement variable metric with respect to the presented advertisement.

In a second illustrative embodiment, a system includes a processor configured to receive an advertisement including a facial recognition delivery instruction. The processor is also configured to capture video or images of a vehicle occupant using a vehicle camera to record user expression state. The processor is further configured to analyze the user expression state and when the user expression state coincides with the facial recognition delivery instruction, deliver the advertisement.

In a third illustrative embodiment, a computer-implemented method includes receiving an advertisement including a facial recognition delivery instruction. The method also includes capturing video or images of a vehicle occupant using a vehicle camera to record user expression state. Further, the method includes analyzing the user expression state and when the user expression state coincides with the facial recognition delivery instruction, delivering the advertisement.

### BRIEF DESCRIPTION OF THE DRAWINGS

FIG. 1 shows an illustrative vehicle computing system;

FIGS. 2A-2D show exemplary facial expressions and analysis;

FIG. 3 shows an illustrative process for analyzing facial expressions;

FIG. 4 shows an illustrative advertisement analysis system;

FIG. 5 shows an illustrative process for advertisement data collection;

FIG. 6 shows a second illustrative process for advertisement data collection;

FIG. 7 shows an illustrative example of facial recognition in a rich media player environment; and

FIG. 8 shows an example of sentiment testing for advertisement evaluation.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen.

In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Increasingly human—machine interfaces approach the abilities of human—human interfaces, largely through machines adopting the abilities of humans. Computers can express themselves as avatars with anthropomorphic voices, gestures and expressions. The illustrative embodiments are concerned with using machine vision to recognize and react appropriately to human facial/emotional expressions in a vehicle.

Attempts have been made to teach computers to understand human subjective emotional expression and pay attention to how humans feel, especially in advertisement fields. Computers have been recording people's reactions to an advertisement, like whether people are smiling, whether people are frowning, whether they're shocked and surprised, and whether they're even paying attention. Facial/body expressions paint a rich canvas of emotional response that provides invaluable insight into advertising, brand effectiveness and product/service satisfaction.

When people listen to a program or ads in a vehicle, the situation is somewhat different than watching TV. Peoples' positions are established by the vehicle's geometry and restraints, and their presence determined by the occupant classification system. Occupants gaze direction is forward most of the time due to the linear and forward nature of travel. To avoid hazardous visual distraction, vehicle media is currently largely audio-oriented. Vehicle recording devices, often due to limited size, typically receive images of the head and face rather than the whole body.

Determination of emotion from images will help measure advertising effectiveness. Doing so will use a strategy for identifying universal human emotions determinable by innate and universal expressions. Two systems for doing this are well known. Darwin was the first to tackle this problem in his famous work “The Expression of the Emotions in Man and Animals” by identifying specific emotions with expressions in both humans and mammals, tracing the animal expressions and emotional behaviors down the evolutionary pathways. Darwin's emotions are considered to be universal since they are observed in both humans and animals, including love, sympathy, hatred, suspicion, envy, jealousy, avarice, revenge, deceit, devotion, slyness, guilt, vanity, conceit, ambition, pride, humility.

More recently the Facial Action Coding System (FACS) developed by Paul Ekman and colleagues have come into popular use. The FACS system identifies seven basic universal emotions that can be reliably determined with either automatic or crowd sourced recognition; anger, disgust, fear, happiness, sadness, surprise and neutral. These are the emotions of the mesolimbic system and can be identified in combination and with estimated intensity. They are widely believed to be universal and involuntary. Several facial expression recognition algorithms have been developed and are implemented in commercial software from sources such as NVISO, Visual Recognition, Noldus FaceReader, etc.

FIGS. 2A-2D show exemplary facial expressions and analysis according the FACS. The eyebrows 201, 211, 221, 231, eyes 203, 213, 223, 233 and mouth 205, 215, 225, 235 are considered to determine varied degrees of emotional content in an expression.

For each facial expression, there are a number of possible emotions that can be determined. In this illustrative example, the emotions are Surprised, Happy, Sad, Puzzled, Disgusted, Angry and Normal. Other emotions can also be added as desired.

Each emotion also has a degree-of-confidence associated therewith, which, in this example, ranges from 0 to 1. As can be seen from FIG. 2A, in an emotional state where the eyebrows 201 are relatively static, the eyes 203 are at a standard degree of openness, and the mouth is largely static, the highest projected emotional state 209 is “normal.” This can represent a baseline expression.

In FIG. 2B, the eyebrows 211 have flattened, the eyes 213 have narrowed and the lips 215 have taken on a downward turn. Based on these observations, the new emotional state 219 with the highest projected degree of confidence is now “sad,” although puzzled is close behind.

In FIG. 2C, the eyebrows 221 are now raised, the eyes are 223 wide opened and the mouth 225 is also wide opened. This new expression has the highest correspondence 229 to “surprise,” although it also has a high correspondence to “happy.”

Finally, in FIG. 2D, the eyebrows 231 have flattened somewhat, the eyes 233 are slightly narrowed and the mouth 235 is upturned. This expression has the highest degree of correspondence 239 to “happy.”

When dealing with a driver, who is communicating with a computer via a VCS during driving to potentially interact with advertisements, make a purchase, or give reviews to some services (e.g. satisfaction to dealership services), detection of subjective emotional expression can play an important role. Currently, one complaint users of such systems may have, is that the systems typically do not respond well to “conversational” dialogue.

A four-year old may understand a conversational sentence with emotions with a higher degree of accuracy than a computing system that cost millions of dollars to develop. This is because these systems often operate off of keywords, and further because the systems often have little to no sense of context and do not understand any emotions. People, on the other hand, may prefer to speak in subjective terms with non-verbal emotion expressions, as opposed to dialogue consisting of a string of spoken, often objective expressions. Instead of an explicit rating review after dealership service experiences, a vehicle occupant may for example, say “it's good” with different emotions (tones) or give facial expressions (big smiles, or neutral), which might have totally different meaning based on facial expressions, tones or gestures, even to the same person.

The competition for advertisement space (and getting product/service reviews) in the vehicle has become intense. Advertising methods used in printed media have now migrated to online advertising, and have started to be in used in the vehicle. The illustrative embodiments provide a safe way to measure the influencing process of in-vehicle advertising, the effectiveness of in-vehicle ads and the satisfaction for post-products/services including subjective emotional expression, and could also collect data in this area to understand more about human emotion expressions.

An exemplary illustrative advertising system consists of a front-end human machine interface, a machine-learning system and expression (facial) recognition system and a back-end control system. In addition, for portability and for enhanced learning, the system uses cloud-based storage and computing. The front-end human machine interface can communicate with drivers and receives the inputs both verbally and non-verbally based on many existing options (voice, touch or facial/emotional expressions, haptics (camera, steering wheel, seat, and controls), etc.). More discussion of this system is provided with respect to FIG. 4.

FIG. 3 shows an illustrative process for analyzing facial expressions. In this illustrative example, the process begins at some point once the user is in the vehicle 301. The user, in this example, can be any occupant who is in view of a vehicular camera. Through facial recognition, the VCS can identify the occupant(s) to be monitored that are in view of a camera. The process scans 303 any potential identifiable subjects/occupants, and determines if the user is in a vehicle database 307.

If the user is in the database, the process retrieves information relating to the user 309. After identifying the user, the person's past ad-click history can be recalled and analyzed. The system begins to learn how to interpret the users' subjective emotional expressions by using the facial/gesture/tone expression recognition software 311.

If the user is new to the system, existing generic models are used as a starting point and based on feedback from the user, the system quickly gets better with each use, and understands the meaning of non-verbal expressions better and better with time. The machine-learning process is based on statistical methods examples of which include the use of contextual bandit, Bayesian learning or artificial neural networks. Once the system has developed a psychometric mapping model of the user, the system with a camera can take a subjective emotional input (e.g. facial expression) and deliver a quantitative command (e.g. yes or no, good or bad) to the vehicle control system.

The front-end control application runs in the vehicle and uses a dialog system including camera to: a) interact with the user and get the feedback for Ads, deals, product testimonials, service, etc.; and b) record users' feedback and body expressions. The cloud-based informational filter (back-end control system): a) processes the input data, obtain relevant user information, b) filters the user responses and remove unnecessary information; and c) classifies and indexes users' expressions, dynamically clusters the user feedbacks into groupings and merges them with users' information (demographics, vehicle information). At any time an advertiser can make requests and the system will retrieve relevant information input. In addition, the machine learning software could process the historical data of individual driver, and recognize this driver's non-verbal expressions better and better with time.

For example, if a driver just finished a dealership service visit and returned to a vehicle, the vehicle may recognize the driver and ask for a review to the experience. The driver may say “good” or just have a big smile or give a thumb-up. The review response would be recorded non-verbally through camera inside the vehicle. The input would be sent to the message cloud first through the control application. A message filter will process the expressions, recognize the emotional expressions and then link it to the review results (rating). After the vehicle sending the results, together with the driver's information (VIN number, demographic information), to advertisers or service providers (e.g. dealers), the advertisers could then determine how to react.

Based on observed verbal and non-verbal responses, the system attempts to gauge if a driver is uninterested (neutral expression, for example) or unsatisfied 313, mildly interested or satisfied 315 or very interested or satisfied 317. If the user is uninterested or unsatisfied, the process may ask questions or try to find reasons why the user reacted in this manner 319. If the user is satisfied, interested or very interested, the process may recommend similar services or advertisements (now or in the future) 321. User's reactions to various services and advertisements can also be stored in a database for future reference.

FIG. 4 shows an illustrative advertisement analysis system. In this illustrative example, a VCS module contains an applink module which can communicate with applications running on a phone or other mobile device 403. This module, for example, can feed advertising data to the mobile device (if ads are provided) so that particular advertisements can be recommended based on observed user preferences. In this illustrative embodiment, an OEM interface application 417 runs on the mobile device between the application 419 and the applink module.

Also provided as a part of the VCS is a non-verbal expression recorder 413. This records the visual expressions generated by the advertising. In conjunction with this recording, applications or advertisements from applications can transmit data about the advertisement, so that the recorder can evaluate advertisements knowing the context of the ads. For example, without limitation, an ad for McDonalds could have tags such as “fast food” and “food” and “hamburgers” associated therewith. When the expression recorded measured expressions to gauge a response to the advertisement, the process could determine that the user enjoyed or disliked ads related to these tags. Further advertisements from other vendors may have only some of the tags associated therewith, so user's reactions to specific tags can be sorted out through repeated observance. For example, another advertisement could be for FIVE GUYS HAMBURGERS. If this only had “food” and “hamburgers” associated therewith, and the user responded favorably to this ad and disfavorably to the McDonald's ad, it could be guessed that the user either doesn't like McDonald's, doesn't like fast food, or wasn't hungry during the McDonald's presentation (among other possible conclusions). Through repeated observance and filtering, a comprehensive set of user preferences can be determined.

The VCS 401 in this example also includes a media player 415, which can be used for advertisement playback. Also providing inputs to the VCS are an HMI (human machine interface) 407 and vehicle systems 409.

The HMI includes, but is not limited to, such elements as a camera, a speaker, speech recognition functions, steering wheel inputs, an instrument panel and a touch screen display. The vehicle systems include, but are not limited to, navigation functions and hardware, driver status measurements (such as workload estimator and driver happiness evaluation), vehicle identification information, and a driver history (i.e., driver profile).

Through the mobile device, the VCS also communicates with the cloud 405. The cloud provides advanced computing resources, which may include servers 421, data managers 423, advertising servers 425 and learning software 427. Since it may be difficult to include enough computing power to analyze facial expressions in a vehicle, the cloud may provide further computing resources for facial analyzation purposes. Images of expressions, or measurements of image data points, or other expression related data may be sent to the cloud for further analysis and evaluation.

FIG. 5 shows an illustrative process for advertisement data collection. In this illustrative example, the process begins by playing an advertisement on a vehicle 501. This advertisement, in addition to being presented to a user, may have data associated therewith that is useful for tracking user reactions not only to the advertisement, but advertisements of similar type. Time data, environmental data and other data may also be tracked, since a user may show more interest in food-based advertising at lunch time, for example. Similarly, the user may be more inclined to utilize a drive-through when it's raining.

As the advertisement is played, facial recognition software engages and begins to record and time stamp user emotions 503. These can be recorded through use of the camera, time stamped for comparison to advertisements (down to fractional portions of the advertisement even) and evaluated as shown in FIGS. 2A-2D. Vehicle context information may also be gathered from the vehicle BS 505. This can include information about vehicle states (speed, location), information about users (number of passengers, weight, size), environmental information (weather, traffic) and any other useful information.

In this example, the system measures at least a number of occupants 507 and a level of driver distraction 507. Driver distraction may be a useful indicator of just how much attention a driver is likely giving to any advertisements, and may be used to temper analysis. If a driver is highly distracted and traffic is heavy, for example, an “angry” response may have nothing to do with the advertisement.

Once the advertisement ends 509, the process may evaluate the range of facial expressions over the time of the advertisement, evaluate context information and evaluate any other relevant variables. This information can be used to update advertising data 513 and the evaluations of the particular advertisement can also be added to a user profile for update 515.

FIG. 6 shows a second illustrative process for advertisement data collection. In this illustrative example, advertisements are keyed to certain emotional states. For example, it may not be desirable to play an advertisement when a user is clearly angry, since the advertiser may not want their product to be subconsciously associated with anger. Advertisers may even pay a premium for having advertisements played when a user is in a particular emotional state.

In this process, the facial recognition software begins to detect an emotional state based on expression 601. As shown in FIGS. 2A-2D, expressions can be evaluated for analysis of driver emotional state. When a desired emotional state has been reached 603, an advertisement begins to play.

As the advertisement plays, facial recognition software again begins to record user emotional states and time stamp the responses 605. This can be useful to determine how successful the advertisement was when presented during a particular emotional state. For example, if a person was in a “sad” state, and an advertisement for a favorite food was played, the person, who may take comfort in food, may move from “sad” to “normal.” Emotional evaluation can also be combined with user actions (i.e., if the vehicle visits the restaurant within the next five minutes) for further analysis. Knowing then, that the user takes comfort in a particular food or food in general, it may be advisable to provide food advertisements when a user is in a “sad” state.

Similarly, there may be no response from a user, or a user's state may move from a “low degree” state, such as sad, to a “worse” state, such as “angry.” If there is a measurable correlation between an ad played in a “sad” state that makes a user “angry,” then it would be advisable to avoid this advertisement (or others of its ilk) during a “sad” state.

As before, vehicular context information can also be gathered 607. This information includes any measurable or reportable variables that may be usable to determine an environment under which an advertisement's success may be gauged. While it may be difficult to discern a user's response based on a given variable in a scenario where a number of variables are present, long-term analysis can help refine the particulars with respect to any given variable.

Also, in this embodiment, a number of occupants and a level of distraction are measured, as was the case with the previous example shown in FIG. 5.

Once the advertisement ends, the process again can analyze the facial recognition over time, context information, and other suitable variables that may have had an effect on a reaction and/or may be evaluated for relation to a given reaction. When a variable “has an effect” on a reaction, this may mean that, under commonly observed circumstances, everything else being neutral, that variable tends to produce a recognized effect (e.g., time=lunchtime, effect=positive response to food ads in general). Thus, under this observed circumstance, based on user visual response to ads at lunchtime, it may be advisable to deliver food advertisements when a time variable equals “lunchtime” (or mealtime, or the equivalent).

Similarly, certain variables may have a relation to a given reaction. For example, if a user is “happy” they may be more inclined to make an “impulse purchase.” Advertisers generally know if their products are considered “impulsive purchases,” and it may be more desirable to run “impulse purchase” ads during user states that correspond to “happy” (under this non-limiting model).

Again, the advertisement data for each advertisement can be updated based on the observed responses 615. This data can then be uploaded to a user profile 617. This data can also be saved to other profiles, such as “group profiles.” A “group profile” is a profile that identifies group responses when an advertisement is played when a group of people is present. It can comprise specific members, demographic type members (e.g., adults and kids) or simply be related to a group of any people being present.

FIG. 7 shows an illustrative example of facial recognition in a rich media player environment. In this illustrative example, the process begins in the same manner as with respect to FIG. 6. A facial recognition process engages 701, and when the proper emotion is recognized or “guessed,” 703, the advertising content will being playback.

While the advertisement is playing, the facial recognition software continues to view and record emotional states 705. Again, in this illustrative example, the states are time stamped, although, in another model, an average state over the course of the advertisement may also be measured.

In this example, the advertisement has an opportunity to dynamically adapt to a driver response 707. Numerous states are shown here, although the advertisement could utilize fewer or more states as appropriate. Additionally, certain states may be grouped together for branching purposes. That is, states which have been determined to elicit a similar response to similar types of advertisements may result in a similar branch of the advertisement being played.

Branching, in this example, is based on an advertisement having dynamic content associated therewith. For example, a mall advertisement may provide some generalize encouragement to shop at a mall. Since a mall has numerous stores and restaurants, there may be an opportunity to tailor the advertisement to a particular user. For example, if a user is sad, but becomes happy when a food-based advertisement is played, the mall advertisement may branch to a food advertisement after generally advertising the mall. Similarly, if a user tends to respond positively to clothing advertisements when a user is happy, the mall advertisement may branch to a clothing advertisement when a user is happy.

In the illustrative embodiment, seven branches of advertisement corresponding to seven emotional states are presented in a non-limiting fashion. Based on whether a user is surprised 709, sad 711, happy 713, angry 715, contemptuous 717, frustrated 719 or neutral 721, a differing advertisement segment is played. In this example, segments corresponding to the various emotions 721, 723, 725, 727, 729, 731, 733 are played, although, as stated, any number of segments may be grouped. Additionally or alternatively, other segments may be added based on other emotions as needed.

Finally, an end segment may be played 735, which can include, for example, dynamic content based on a previous segment, or can merely be a static segment. The advertisement may then be repeated or ended as appropriate 737.

FIG. 8 shows an example of sentiment testing for advertisement evaluation. In this illustrative embodiment, a particular advertisement is sent to a vehicle for sentiment testing. For example, if a vendor develops an advertisement that may be of questionable application, the vendor may wish to test this advertisement against a variety of users and user states before general distribution, to get a sense of when the advertisement is likely to be met with a measure of success.

The advertisement is sent to vehicles, including sentiment test instructions and a time delay 801. At the appropriate times, the advertisement may play back in the vehicle. This may include multiple playbacks based on predefined intervals of playback 803. Also, based on a time following a preset interval (which may be used to gauge reaction over time), the process will perform a sentiment test 805.

The test may begin, for example, with asking a question about an occupant's opinion about a product 807. Responsively, the driver may provide input about the product and a joining opinion 809. Additionally the in-vehicle cameras may record imagery 811 and time stamps. These images and timestamps may be analyzed and correlated to moments of the presented advertisements 813.

Further, the images may be analyzed for measurable emotions as a driver speaks specific words 815. Since speech is within the province of measurement in this illustrative example, the mouth may be ignored in the analysis of facial recognition. In another example, the mouth may be included in instances only when voice input is not measured.

Time delays between when questions are asked and when they are answered are recorded as a measure of familiarity with the questions 817. Also, advertisements and associated measurable indicia are recorded and updated as appropriate based on the measured factors and variables 819. Further, advertisement effectiveness based on observed indicia may be recorded 821.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive an advertisement;
present the advertisement to a vehicle occupant;
visually record an occupant response during the course of the advertisement presentation using a vehicle camera;
analyze the visually recorded response to gauge a user reaction to the advertisement; and
based on the analysis adjust an advertisement variable metric with respect to the presented advertisement.

2. The system of claim 1, wherein the advertisement presentation includes visual presentation.

3. The system of claim 1, wherein the advertisement presentation includes audible presentation.

4. The system of claim 1, wherein the processor is configured to record a user response via a vehicle camera.

5. The system of claim 1, wherein the user response includes a facial expression.

6. The system of claim 5, wherein the analysis of the facial expression results in a determined user emotion state.

7. The system of claim 6, wherein the user emotion state is used to update a user profile with a user response to the advertisement based on the emotion state.

8. A system comprising:
a processor configured to:
receive an advertisement including a facial recognition delivery instruction;
capture video or images of a vehicle occupant using a vehicle camera to record user expression state;
analyze the user expression state; and
when the user expression state coincides with the facial recognition delivery instruction, deliver the advertisement.

9. The system of claim 8, wherein the facial recognition delivery instruction includes an instruction to deliver the advertisement during a facial state corresponding to a particular emotion.

10. The system of claim 8, wherein the facial recognition delivery instruction is based at least in part on previously observed responses under which similar advertisements were delivered with positively recorded responses.

11. The system of claim 8, wherein the facial expression is recorded over the course of advertisement delivery in predefined segments.

12. The system of claim 8, wherein the processor is further configured to record user facial expression during advertisement delivery and update a user profile with a user response to the advertisement based on the recorded user facial expression.

13. The system of claim 12, wherein the predefined segments are correlated during the update of the advertisement response to correspond to specific advertisement segments.

14. A computer-implemented method comprising:
receiving an advertisement including a facial recognition delivery instruction;
capturing video or images of a vehicle occupant using a vehicle camera to record user expression state;
analyzing the user expression state; and
when the user expression state coincides with the facial recognition delivery instruction, delivering the advertisement.

15. The method of claim 14, wherein the facial recognition delivery instruction includes an instruction to deliver the advertisement during a facial state corresponding to a particular emotion.

16. The method of claim 14, wherein the facial recognition delivery instruction is based at least in part on previously observed responses under which similar advertisements were delivered with positively recorded responses.

17. The method of claim 14, wherein the facial expression is recorded over the course of advertisement delivery in predefined segments.

18. The method of claim 14, wherein the method further includes recording user facial expression during advertisement delivery and updating a user profile with a user response to the advertisement based on the recorded user facial expression.

19. The system of claim 18, wherein the predefined segments are correlated during the update of the advertisement response to correspond to specific advertisement segments.
